(19) United States
(12) Patent Application Publication
(10) Pub. No.: US 2003/0209551 A1
(43) Pub. Date: Nov. 13, 2003

(54) Heat-keeping cover for a cooking vessel

(76) Inventor: Jong Peter Park, Diamond Bar, CA (US)

Correspondence Address: JONG PETER PARK, 1630 SUMMITRIDGE DR., DIAMOND BAR, CA, 91765, US

(21) Appl. No.: 10/213,005

(22) Filed: Aug. 6, 2002

(30) Foreign Application Priority Data
May 12, 2002 (KR) 10-2002-0032758

(51) Int. Cl. B65D 51/00; A47J 37/01

(52) U.S. Cl. 220/573.1; 220/592.22; 220/377; 220/912

(57) ABSTRACT

Disclosed is a heat-keeping cover for a cooking including a transparent window comprising a pair of glass discs so as to leave an interval or space in between, a metal rim coupled with an edge of the transparent window, and a over handle coupled with a center of the transparent window, herein the heat-keeping cover is for applying predetermined pressure and heat to the pot and reducing heat dissipation from the pot. The metal rim comprises dual stainless steel plates having an airtight inner space inside. The airtight inner space is filled with a heat medium for heat-keeping. The cover handle includes a metal sensor installed at a hole formed at a center of the transparent window so as to sense a temperature under the cover through the hole and a knob coupled with the metal sensor so as to play a role of a thermometer protruding out of the transparent window.

### BACKGROUND OF THE INVENTION

1. Field of the Invention

The present invention relates to a cover for a cooking vessel, specifically to such covers intended to contain heat energy.

2. Background of the Related Art

A purpose of a cooking vessel cover is to cover a cooking vessel body. Such covers are used to contain heat energy when a cooking vessel is placed on a heat source. When a cooking vessel is heated with its cover on, the pressure inside the cooking vessel rises, and, in instances when the pressure escalates to a certain level, the pressure pushes the weight of the cover outwards in order to depressurize.

Some cooking vessel covers, such as a pressure cooker cover, comes with a valve that automatically discharges excess pressure when the inner pressure reaches a predetermined level. In such cases where the cover is for a pressure cooker, a cover is tightly coupled with its body so as to make the inner space of the pot airtight in order to apply optimal heat and pressure on the food to be cooked.

A pressure cooker, with its cover and body, maintains an airtight state of its inner space for a period of time, even though the pressure in its inner space exceeds atmospheric pressure level.

A structure of a cooking vessel cover, such as a pressure cooker cover, can be complicated. Coupling parts for assembly and disassembly with the pot body and various parts for attaching a lid to the pot can include components or various parts for assembly and disassembly with the pot body and a safety valve for discharging externally pressure exceeding a predetermined value.

Unfortunately, the pressure pot cover according to the related art fails to accomplish easy operation of being coupled with the pot body.

Moreover, the pressure pot cover according to the related art is mostly made of metal, thereby failing to avoid massive heat loss.

### SUMMARY OF THE INVENTION

Accordingly, the present invention is directed to a cover for a cooking vessel that substantially obviates one or more problems due to limitations and disadvantages of the related art.

An object of the present invention is to provide a heat-keeping cover for a cooking vessel enabling to reinforce a heat-keeping function as well as make contents inside the pot be seen through from outside the cooking vessel.

Another object of the present invention is to improve the insulating functionality of a cooking vessel cover.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a heat-keeping cover for a cooking vessel according to the present invention includes a transparent window comprising a pair of glass discs so as to leave an interval or space in between, a metal rim coupled with an edge of the transparent window, and a cover handle coupled with a center of the transparent window, wherein the heat-keeping cover is for applying predetermined pressure and heat to the pot and reducing heat dissipation from the pot.

Preferably, the metal rim comprises dual stainless steel plates having an airtight inner space inside.

More preferably, the airtight inner space is filled with a heat medium for heat-keeping.

More preferably, the heat medium is a chemical composed of silicon oil.

More preferably, a circumference of the metal rim is bent so as to form a groove inward the circumference and a packing is installed at the groove.

Preferably, the cover handle includes a metal sensor installed at a hole formed at a center of the transparent window so as to sense a temperature under the cover through the hole and a knob coupled with the metal sensor so as to play a role of a thermometer protruding out of the transparent window.

Preferably, the cover handle includes a support rod inserted in a hole formed at a center of the transparent window and a knob coupled with the support rod so as to protrude out of the transparent window.

Preferably, the cover handle includes a support rod made of a metal sensor sensing a temperature inside the pot and a knob coupled with the metal sensor so as to play a role of a thermometer.

Preferably, the heat-keeping cover further includes a safety valve providing a pressure discharge path penetrating the cover when a pressure under the cover exceeds a predetermined value.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a cross-sectional view of a pot covered with a heat-keeping cover according to the present invention; and

FIG. 2 illustrates a layout of a heat-keeping pot cover according to the present invention.

### DETAILED DESCRIPTION OF THE PREFERRED EMBODIMENTS

Reference will now be made in detail to the preferred embodiments of the present invention, examples of which are illustrated in the accompanying drawings.

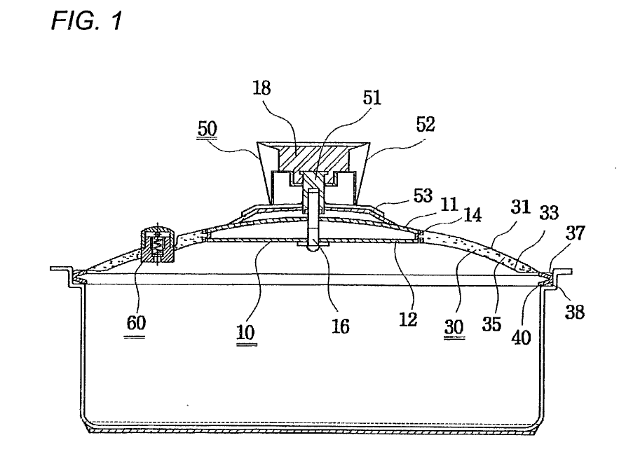

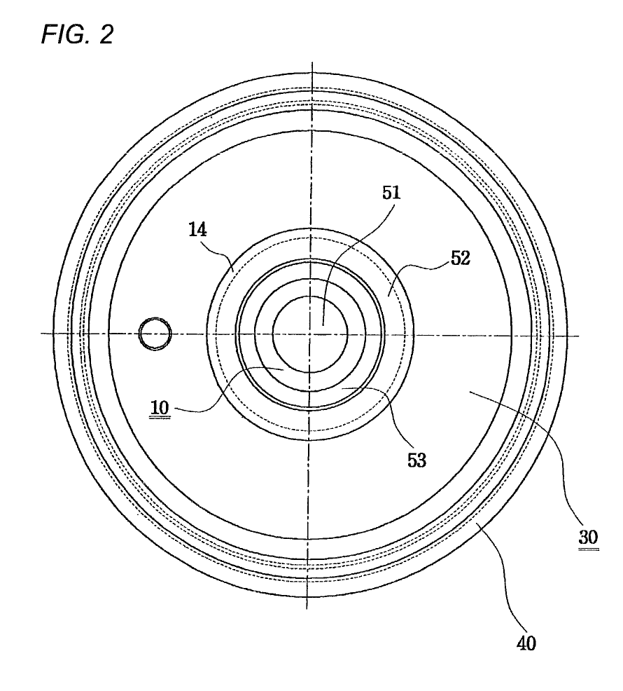

FIG. 1 illustrates a cross-sectional view of a pot covered with a heat-keeping cover according to the present invention, and FIG. 2 illustrates a layout of a heat-keeping pot cover according to the present invention.

A heat-keeping pot cover according to the present invention includes a transparent window 10 constituted with a pair of glass discs 11 and 12 coupled with each other so as to leave an interval or space between the glass discs, a metal rim 30 coupled with an edge of the transparent window, and a cover handle 50 coupled with a center of the transparent window. Besides, the heat-keeping pot cover further includes a safety valve 60 so as to provide a pressure discharge path penetrating the heat-keeping cover when a pressure of a lower part (i.e. an inside of a pot) exceeds a predetermined value.

The transparent window 10 is constituted with a pair of the glass discs 11 and 12. A ring type packing 14 is fixed to the edge, a hole is formed at the center, a bolt type support rod 16 having a screw is inserted in the hole, and the support rod 16 is coupled with a nut 18 so as to be fastened. The transparent window 10 is made of tempered glass, and the packing 14 is made of silicon rubber.

The metal rim 30 includes a pair of stainless steel plates 31 and 33 sealed with each other so as to make an inner space airtight. The inner space of the metal rim 30 is filed with a chemical containing silicon oil 35, a circumference 37 of the metal rim 30 is bent to form a groove 38 inward the circumference, and a sealing packing 40 is installed at the groove 38.

Central edges of the stainless steel plates 31 and 33 are welded to each other. In this case, a welding portion protrudes like a “⊥” shape out of the welded portion so as to be fitted to the packing 14. And, an edge of the circumference is also welded so as to make the inner space of the metal rim 30 airtight completely. Besides, a hole for installing the safety valve 60 is formed at the metal rim 30, and the silicon oil 35 is injected in the metal rim 30 through the hole.

The handle 50 is coupled with a coupling body of the support rod 16 and nut 18 of the transparent window. A nut is coupled with the handle in one body so as to fasten strongly a pair of the tempered glass plates by a screw coupling with the support rod 16.

A thermometer 51 indicating a temperature of the support rod 16 is built inside a handle knob 52 of the handle 50 so as to provide various functions. The thermometer 51 senses a temperature under the transparent window, i.e. inside the pot through the support rod 16 so as to indicate the temperature by calibrations.

The handle knob 52 is built in one body of the nut 18, and an eave portion 53 is formed at a part attached to glass so as to generate elasticity like a washer when the nut is fastened. Therefore, the thermometer 51 is coupled in one body with the nut 18 fastening the support rod 16, and the knob 52 surrounds the periphery of the nut 18. In this case, the support rod 16 plays a role as a metal sensor transferring heat inside the pot to the thermometer 51.

Instead, for simplicity, the handle 50 may include a support rod inserted in the hole formed at the center of the transparent window and a knob coupled with the support rod so as to protrude out of the transparent window.

The transparent window constituted with dual glasses according to the present invention enables to inform a user of a cooking status of food inside the pot without opening the cover, the dual glasses lessens heat dissipation so as to save fuel for cooking, and the transparent window plays a role in keeping the cooked food warm for a long time.

The metal rim protects the edges of the dual glasses from a shock impacted thereon when the pot cover is used. The metal rim is constituted with a pair of the stainless steel plates so as to leave the interval charged with the silicon oil to reinforce the heat-keeping function.

Moreover, the circumference of the metal rim is bent downward so as to provide the groove inward the pot, and the packing is installed at the groove so as to isolate the inside of the pot from outside when the cover is coupled with the pot body.

The knob used as a handle plays a role of a thermometer indicating the temperature of the inside of the pot as well, thereby informing a user of the temperature inside the pot with ease. And, the temperature inside the pot (under the dual glasses) is sensed through the metal sensor, thereby enabling to reduce an error between the indicated temperature and a real temperature. Besides, the metal sensor plays a role of a coupling rod as well so as to couple the upper and lower glasses with each other.

Accordingly, the transparent window made of the dual glasses informs a user of the cooking status of the food inside the pot without opening the cover, thereby providing the user with convenience.

Moreover, the transparent window is made of the dual glasses, the metal rim is made of the dual plates, and the metal rim is filed with a heat-keeping fluid (silicon oil) so as to reduce the heat dissipation. Therefore, the present invention enables to save the fuel for cooking as well as keep the cooked food warm for a long time.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

I claim:

1. A heat-keeping cover for a pot, comprising:
a transparent window comprising a pair of glass discs so as to leave an interval in between said pair of glass discs;
a metal rim coupled with an edge of the transparent window; and
a cover handle coupled with a center of the transparent window,
wherein the heat-keeping cover is for applying predetermined pressure and heat to the pot and reducing heat dissipation from the pot.

2. The heat-keeping cover of claim 1, wherein said metal rim comprises dual stainless steel plates having an airtight inner space inside.

3. The heat-keeping cover of claim 2, wherein said airtight inner space is filled with a heat medium for heat-keeping.

4. The heat-keeping cover of claim 3, wherein the heat medium is a silicon oil.

5. The heat-keeping cover of claim 2, wherein a circumference of the metal rim is bent so as to form a groove inward the circumference and a packing is installed at the groove.

6. The heat-keeping cover of claim 1, said cover handle comprising:
a metal sensor installed at a hole formed at a center of said transparent window so as to sense a temperature under the cover through the hole; and
a knob coupled with the metal sensor so as to play a role of a thermometer protruding out of the transparent window.

7. The heat-keeping cover of claim 1, said cover handle comprising:
a support rod inserted in a hole formed at a center of the transparent window; and
a knob coupled with the support rod so as to protrude out of the transparent window.

8. The heat-keeping cover of claim 1, the cover handle comprising:
a support rod made of a metal sensor sensing a temperature inside the pot; and
a knob coupled with the metal sensor so as to play a role of a thermometer.

9. The heat-keeping cover of one of claims 1 to claims 7, further comprising a safety valve providing a pressure discharge path penetrating the cover when a pressure under the cover exceeds a predetermined value.
